(19) United States
(12) Patent Application Publication
(10) Pub. No.: US 2025/0155655 A1
(43) Pub. Date: May 15, 2025

(54) FIBER BUNDLE CONNECTOR AND FIBER CONNECTOR MANUFACTURING METHOD

(71) Applicant: Fujikura Ltd., Tokyo (JP)

(72) Inventor: Kohei Ozaki, Sakura-shi (JP)

(73) Assignee: Fujikura Ltd., Tokyo (JP)

(21) Appl. No.: 18/833,980

(22) PCT Filed: Sep. 28, 2022
(86) PCT No.: PCT/JP2022/036054

§ 371 Date: Jul. 29, 2024

(30) Foreign Application Priority Data
Feb. 1, 2022 (JP) 2022-014270

(51) Int. Cl. G02B 6/40; G02B 6/25

(52) U.S. Cl. CPC G02B 6/403; G02B 6/25

(57) ABSTRACT

A fiber bundle connector includes a plurality of optical fibers and a ferrule that has a connection end surface and a fiber hole that extends to the connection end surface and into which the plurality of optical fibers are inserted. On at least the connection end surface, a plurality of optical fibers inserted into the fiber hole are most densely disposed such that adjacent optical fibers are in contact with each other, and all the optical fibers located at an outermost periphery among the plurality of optical fibers disposed most densely are pressed on an inner wall of the fiber hole to cause the inner wall to elastically and plastically deform.

### TECHNICAL FIELD

The present invention relates to a fiber bundle connector and a fiber connector manufacturing method.

Priority is claimed on Japanese Patent Application No. 2022-014270, filed on Feb. 1, 2022, the content of which is incorporated herein by reference.

### BACKGROUND ART

In recent years, with the increase in the amount of data to be transmitted, high-density disposition of a plurality of optical fibers for performing data communication has been promoted. Patent Document 1 discloses a fiber bundle connector in which a plurality of optical fibers are bundled and inserted into a fiber hole of a ferrule, as one method of disposing a plurality of optical fibers at a high density. The plurality of optical fibers inserted into the fiber hole are exposed on a connection end surface of the ferrule. In such a fiber bundle connector, the connection end surface of the fiber bundle connector is butted against a connection end surface of another optical fiber connector, so that the optical fibers exposed on the connection end surfaces of these two connectors are optically connected to each other.

### CITATION LIST

### Patent Document

### [Patent Document 1]

Japanese Unexamined Patent Application, First Publication No. 2013-125195

### SUMMARY OF INVENTION

### Technical Problem

In this type of fiber bundle connector, it is necessary to position a plurality of optical fibers on a connection end surface of a ferrule with high accuracy. In a case where this is not possible, there is a problem in that connection loss between the optical fiber of the fiber bundle connector and an optical fiber of another optical fiber connector is increased.

The present invention has been made in view of the above-described circumstances, and an object of the present invention is to provide a fiber bundle connector capable of suppressing connection loss, and a fiber connector manufacturing method.

### Solution to Problem

According to a first aspect of the present invention, a fiber bundle connector includes a plurality of optical fibers, and a ferrule has a connection end surface and a fiber hole that extends to the connection end surface and into which the plurality of optical fibers are inserted. The plurality of optical fibers inserted into the fiber hole are most densely disposed on at least the connection end surface such that adjacent optical fibers are in contact with each other, and all the optical fibers located at an outermost periphery among the plurality of optical fibers disposed most densely are pressed on an inner wall of the fiber hole to cause the inner wall to elastically and plastically deform.

According to a second aspect of the present invention, a fiber connector manufacturing method for manufacturing a fiber connector including an optical fiber, and a ferrule having a connection end surface and a fiber hole that extends to the connection end surface and into which the optical fiber is inserted. The method includes a fiber preparation step of preparing an insertion optical fiber in which a tip end portion and a base end portion that has a diameter larger than a diameter of the tip end portion are arranged continuously, in which in a cross section perpendicular to a longitudinal direction of the insertion optical fiber, a circumscribed circle when the tip end portion is most densely disposed is smaller than an inscribed circle of the fiber hole in at least the connection end surface, and a circumscribed circle when the base end portion is most densely disposed is larger than at an inscribed circle of the fiber hole in at least the connection end surface, a fiber insertion step of inserting the base end portion of the insertion optical fiber into the fiber hole by inserting the tip end portion of the insertion optical fiber into the fiber hole and pulling the tip end portion of the insertion optical fiber out from the connection end surface after the fiber preparation step, and a cutting step of removing the tip end portion of the insertion optical fiber pulled out from the connection end surface by cutting the insertion optical fiber in the connection end surface after the fiber insertion step. In a state after the fiber insertion step, the base end portion of every insertion optical fiber located at an outermost periphery among the base end portion of the insertion optical fiber inserted into the fiber hole is pressed on an inner wall of the fiber hole to cause the inner wall to elastically and plastically deform, and, in a state after the cutting step, the base end portion of the insertion optical fiber functions as the optical fiber in the fiber connector.

According to a third aspect of the present invention, a fiber connector manufacturing method for manufacturing a fiber connector including an optical fiber, and a ferrule having a connection end surface and a fiber hole that extends to the connection end surface and into which the optical fiber is inserted. The method includes a ferrule preparation step of preparing a ferrule in which, in a cross section perpendicular to a longitudinal direction of the fiber hole, an inscribed circle of the fiber hole in at least the connection end surface is larger than a circumscribed circle when the optical fiber is most densely disposed, wherein the ferrule being molded of resin, a fiber insertion step of inserting the optical fiber into the fiber hole after the ferrule preparation step, and an annealing step of annealing the ferrule after the fiber insertion step, so that the inscribed circle of the fiber hole in at least the connection end surface is made to be smaller than the circumscribed circle when the optical fiber is most densely disposed. In a state after the annealing step, the optical fiber located at an outermost periphery among the optical fiber inserted into the fiber hole is pressed on an inner wall of the fiber hole to cause the inner wall to elastically and plastically deform.

### Advantageous Effects of Invention

According to the above-described aspects of the present invention, when connection end surfaces of the fiber bundle connector or the fiber connector are butted against a connection end surface of another optical fiber connector, it is possible to suppress connection loss between optical fibers of these connectors.

### BRIEF DESCRIPTION OF DRAWINGS

FIG. 1 is a perspective view showing a fiber bundle connector according to an embodiment of the present invention.

FIG. 2 is an enlarged view of a II part in FIG. 1.

FIG. 3 is a side view showing an insertion optical fiber used in a first manufacturing method of manufacturing the fiber bundle connector of FIGS. 1 and 2.

FIG. 4 is a cross-sectional view showing a manufacturing process of the first manufacturing method of the fiber bundle connector.

FIG. 5 is an arrow view taken along line V-V of FIG. 4.

FIG. 6 is a cross-sectional view showing the manufacturing process of the first manufacturing method of the fiber bundle connector following FIG. 4.

FIG. 7 is an arrow view taken along line VII-VII of FIG. 6.

FIG. 8 is a cross-sectional view showing the manufacturing process of the first manufacturing method of the fiber bundle connector following FIG. 6.

FIG. 9 is a cross-sectional view showing a manufacturing process of a second manufacturing method of manufacturing the fiber bundle connector of FIGS. 1 and 2.

FIG. 10 is an arrow view taken along line X-X of FIG. 9.

FIG. 11 is a cross-sectional view showing the manufacturing process of the second manufacturing method of the fiber bundle connector following FIGS. 9 and 10.

FIG. 12 is an enlarged view showing a first modification example of the fiber bundle connector.

FIG. 13 is an enlarged view showing a second modification example of the fiber bundle connector.

FIG. 14 is an enlarged view showing a third modification example of the fiber bundle connector.

FIG. 15 is an enlarged view showing a fourth modification example of the fiber bundle connector.

### DESCRIPTION OF EMBODIMENTS

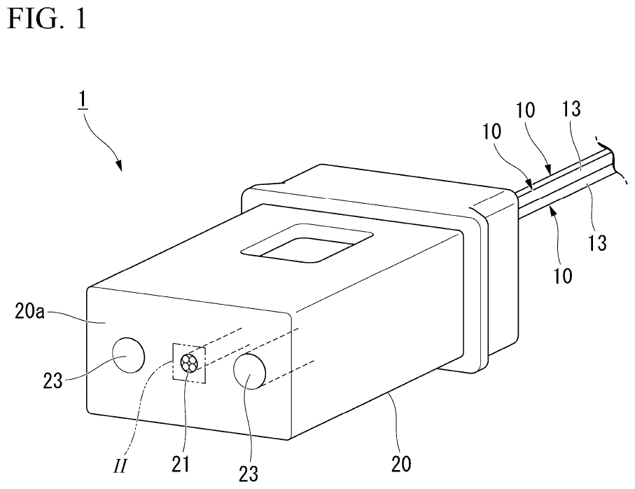

Hereinafter, an embodiment of the present invention will be described with reference to FIGS. 1 to 11.

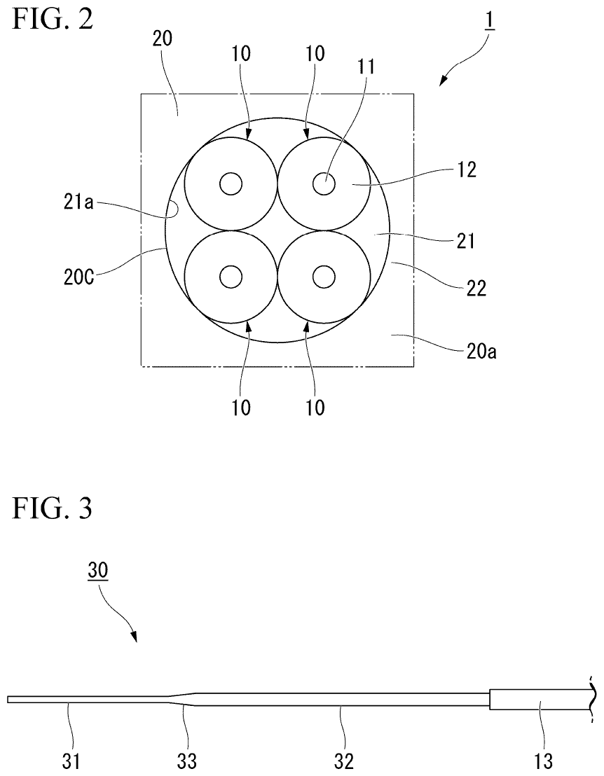

As shown in FIGS. 1 and 2, a fiber bundle connector 1 includes a plurality of optical fibers 10 and a ferrule 20.

As shown in FIG. 2, the plurality of optical fibers 10 are single core fibers each having a glass body including a core 11 and a cladding 12. The glass body of each optical fiber 10 has a circular shape in a cross section perpendicular to a longitudinal direction of the optical fiber 10. The glass body of the optical fiber 10 is inserted into a fiber hole 21 of the ferrule 20 which will be described later. In the present embodiment, each optical fiber 10 includes a coating portion 13 that coats the glass body. The coating portion 13 is provided at a part of the optical fiber 10 that extends to an outside of the ferrule 20.

As shown in FIGS. 1 and 2, the ferrule 20 includes a connection end surface 20a and the fiber hole 21. The fiber hole 21 penetrates the ferrule 20 and extends to the connection end surface 20a. The plurality of optical fibers 10 are inserted into one fiber hole 21. End surfaces of glass bodies of the plurality of optical fibers 10 inserted into the fiber hole 21 are exposed in the connection end surface 20a of the ferrule 20. The number of fiber holes 21 in the ferrule 20 in the present embodiment is one but may be plural.

The ferrule 20 in the present embodiment includes two guide holes 23. The two guide holes 23 penetrate the ferrule 20 and extend to the connection end surface 20a, similar to the fiber hole 21. The two guide holes 23 are parallel to the fiber hole 21. The two guide holes 23 are disposed such that the fiber hole 21 is located therebetween. A guide pin (not shown) can be inserted into the guide hole 23. The guide hole 23 and the guide pin are used for positioning when the fiber bundle connector 1 is connected to another optical fiber connector.

As shown in FIG. 2, in a state in which the glass bodies of the plurality of optical fibers 10 (may also simply be referred to as the optical fibers 10 below) are inserted into one fiber hole 21, the optical fibers 10 adjacent to each other are disposed to be in contact with each other. A state in which the optical fibers 10 adjacent to each other are disposed to be in contact with each other as described above is referred to below as a state in which the optical fibers 10 are most densely disposed. In addition, among the plurality of optical fibers 10 disposed most densely in one fiber hole 21, every optical fiber 10 located at the outermost periphery is in contact with an inner wall 22 of the fiber hole 21. In the fiber hole 21, the optical fiber 10 located at the outermost periphery among the plurality of optical fibers 10 is pressed on the inner wall 22, and the inner wall 22 elastically and plastically deforms.

In the present embodiment, the shape of an inner surface 21a of the fiber hole 21 when viewed from the longitudinal direction of the fiber hole 21 is circular. Four optical fibers 10 (glass bodies) are inserted into the fiber hole 21. The four optical fibers 10 disposed most densely in the fiber hole 21 are all located at the outermost periphery. Therefore, the four optical fibers 10 are pressed on the inner wall 22 of the fiber hole 21.

The structure of the ferrule 20 including the fiber hole 21 will be described below. The inner wall 22 of the fiber hole 21 of the ferrule 20 is the inner surface 21a of the fiber hole 21 and a part of the ferrule 20 located near the inner surface 21a, and is formed to elastically and plastically deform. It is preferable that the elastic modulus of the inner wall 22 of the fiber hole 21 be lower than the elastic modulus of the optical fiber 10 (glass body). That is, the inner wall 22 of the fiber hole 21 is more likely to elastically deform than the glass body of the optical fiber 10. In addition, in a cross section perpendicular to the longitudinal direction of the fiber hole 21, an inscribed circle 20C (see FIG. 2) of the fiber hole 21 is smaller than a circumscribed circle (not shown) when the plurality of optical fibers 10 inserted into the fiber hole 21 are most densely disposed. As shown in FIG. 2, the inscribed circle 20C of the fiber hole 21 in the present embodiment is the same as the contour of the fiber hole 21 which is circular.

The fiber hole 21 after the optical fiber 10 is inserted and the inner wall 22 elastically and plastically deforms may have a substantially circular shape. For example, the inner diameter of the fiber hole 21 may be equal to the diameter of the circumscribed circle of the optical fiber 10 at a part of the fiber hole 21 which is in contact with the optical fiber 10, and may be smaller than the diameter of the circumscribed circle of the optical fiber 10 at other parts that are not in contact with the optical fiber 10. In this case, the inscribed circle 20C is a circle inscribed in a portion of the fiber hole 21 having the smallest inner diameter after the elastic and plastic deformation.

A specific material or a manufacturing method of the ferrule 20 may be optional. The ferrule 20 in the present embodiment is manufactured by resin molding. The resin forming the ferrule 20 may be, for example, thermoplastic resin. Examples of the thermoplastic resin include PPS (polyphenylene sulfide), PBT (polybutylene terephthalate), PEEK (polyether ether ketone), LCP (liquid crystal polymer), PEI (polyetherimide), COP (cyclic olefin polymer), and COC (cyclic olefin copolymer). PPS, PBT, PEEK, and LCP are crystalline resin, and PEI is amorphous resin. In addition, COC and COP are amorphous optical resins capable of transmitting light.

In the fiber bundle connector 1 in the present embodiment, the inner wall 22 of the fiber hole 21 elastically and plastically deforms by the pressing of the optical fiber 10, and the relative position between the optical fiber 10 and the fiber hole 21 is fixed in a state in which there is no clearance between the optical fiber 10 and the fiber hole 21. As a result, it is possible to fix the optical fiber 10 to the ferrule 20 at a desired position with high accuracy. As a result, when the connection end surface 20a of the fiber bundle connector 1 is butted against another optical fiber connector, it is possible to suppress connection loss between the optical fibers of these connectors.

The above-described fiber bundle connector 1 can be manufactured by two different manufacturing methods. The two manufacturing methods of the fiber bundle connector 1 will be described below.

### <First Manufacturing Method>

First, a first manufacturing method of the fiber bundle connector 1 will be described with reference to FIGS. 3 to 8.

In the first manufacturing method, first, a fiber preparation step of preparing an insertion optical fiber 30 shown in FIG. 3 is performed. In the insertion optical fiber 30, a tip end portion 31 and a base end portion 32 having a diameter larger than that of the tip end portion 31 are continuously arranged in a longitudinal direction of the insertion optical fiber 30. The tip end portion 31 and the base end portion 32 consist of a glass body (core 11 and cladding 12 shown in FIG. 2). The diameters of the tip end portion 31 and the base end portion 32 are each constant in the longitudinal direction of the insertion optical fiber 30. The tip end portion 31 and the base end portion 32 have different diameters based on a difference in the thickness of the cladding 12.

The tip end portion 31 and the base end portion 32 of the insertion optical fiber 30 may be connected to each other, for example, in a step shape. In the insertion optical fiber 30 in the present embodiment, a tapered portion 33 made of a glass body is located between the tip end portion 31 and the base end portion 32. The tapered portion 33 is formed in a tapered shape in which a diameter increases toward the base end portion 32 from the tip end portion 31.

In the insertion optical fiber 30 in the present embodiment, the tip end portion 31, the base end portion 32, and the tapered portion 33 consisting of the glass body protrude from the coating portion 13 that coats the glass body. The base end portion 32, the tapered portion 33, and the tip end portion 31 are arranged in this order from an end portion of the coating portion 13.

In the first manufacturing method in the present embodiment, four insertion optical fibers 30 described above are prepared. The diameters of the tip end portions 31 and the base end portions 32 of the four insertion optical fibers 30 are set to satisfy the following two conditions.
First condition: as shown in FIG. 5, in a cross section perpendicular to the longitudinal direction of the insertion optical fiber 30, a circumscribed circle 31C when the tip end portions 31 of the four insertion optical fibers 30 are most densely disposed is smaller than an inscribed circle 20C of a fiber hole 21.
Second condition: a circumscribed circle (not shown) when the base end portions 32 of the four insertion optical fibers 30 are most densely disposed is larger than the inscribed circle 20C (see FIG. 7) of the fiber hole 21. More specifically, the circumscribed circle when the base end portions 32 of the insertion optical fibers 30 are most densely disposed is larger than the inscribed circle 20C of the fiber hole 21 before the optical fiber 10 is inserted, and is larger than the inscribed circle 20C of the fiber hole 21 after the elastic and plastic deformation. In the example shown in FIG. 7, the inscribed circle 20C of the fiber hole 21 is the same as the contour of the fiber hole 21 which is circular.

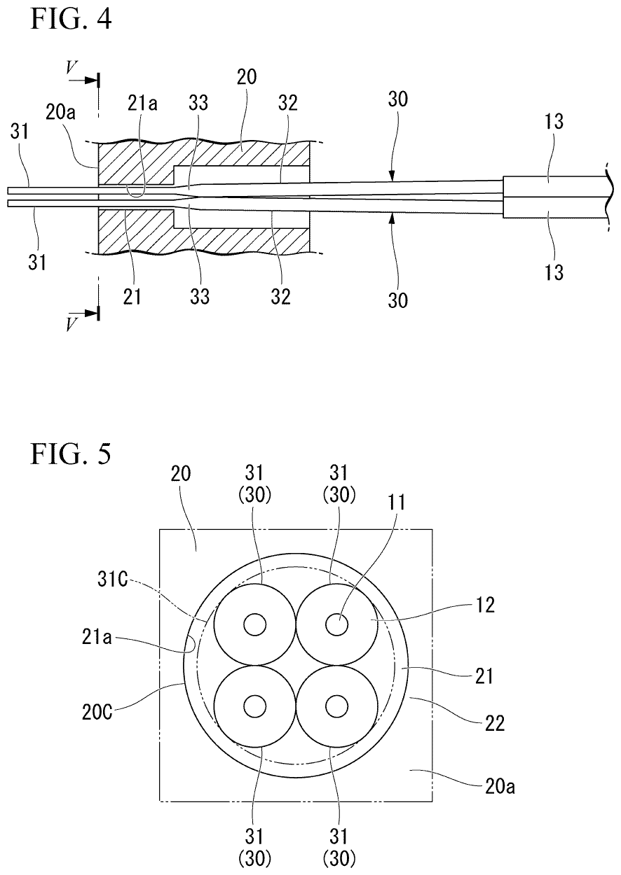

After the above-described fiber preparation step, a fiber insertion step of inserting four insertion optical fibers 30 into the fiber hole 21 of the ferrule 20 is performed as shown in FIGS. 4 to 7. In the fiber insertion step, first, as shown in FIGS. 4 and 5, the tip end portions 31 of the four insertion optical fibers 30 are inserted into the fiber hole 21 of the ferrule 20 to be caused to protrude from the connection end surface 20a of the ferrule 20. Here, as described above, the circumscribed circle 31C when the tip end portions 31 of the four insertion optical fibers 30 are most densely disposed is smaller than the inscribed circle 20C of the fiber hole 21. Therefore, it is possible to easily insert the tip end portions 31 of the four insertion optical fibers 30 into the fiber hole 21.

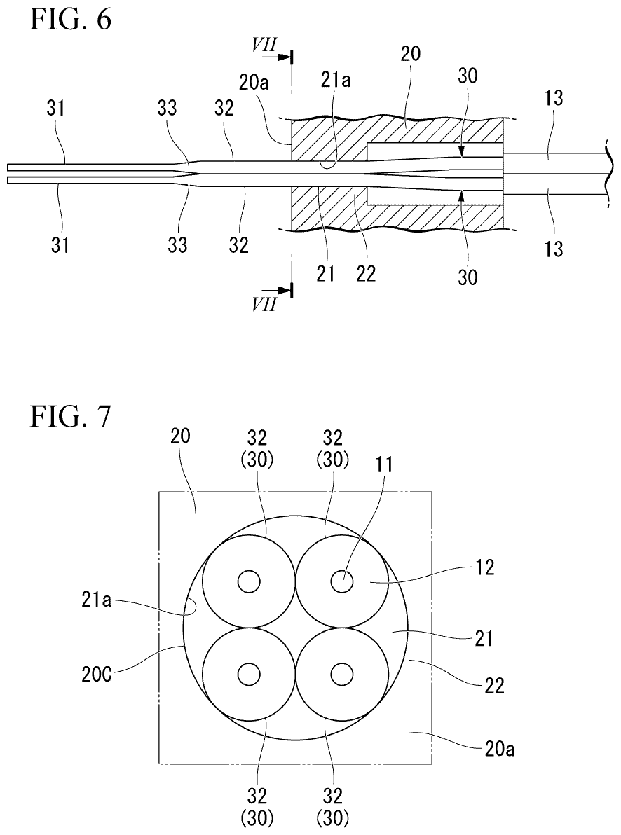

Thereafter, in the fiber insertion step, as shown in FIG. 6, the tip end portions 31 of the four insertion optical fibers 30 inserted into the fiber hole 21 are pulled out from the connection end surface 20a of the ferrule 20. As a result, as shown in FIGS. 6 and 7, the base end portions 32 of the four insertion optical fibers 30 are inserted into the fiber hole 21. Here, as described above, the circumscribed circle (not shown) when the base end portions 32 of the four insertion optical fibers 30 are most densely disposed is larger than the inscribed circle 20C of the fiber hole 21. Therefore, in a state in which the base end portions 32 of the four insertion optical fibers 30 are inserted into the fiber hole 21, the base end portions 32 located at the outermost periphery among these four base end portions 32 are pressed on the inner wall 22 of the fiber hole 21, and the inner wall 22 elastically and plastically deforms. In this case, all the four base end portions 32 are pressed on the inner wall 22 of the fiber hole 21, and the inner wall 22 elastically and plastically deforms.

In addition, the insertion optical fiber 30 in the present embodiment includes the tapered portion 33 between the tip end portion 31 and the base end portion 32 thereof. Therefore, it is possible to easily insert the base end portion 32 of the insertion optical fiber 30 into the fiber hole 21 after the inner wall 22 of the fiber hole 21 is gradually pushed by the tapered portion 33 of the insertion optical fiber 30.

In the fiber insertion step, as shown in FIG. 6, the insertion optical fiber 30 only needs to be inserted into the fiber hole 21 such that the base end portion 32 of the insertion optical fiber 30 reaches a position corresponding to the connection end surface 20a of the ferrule 20, that is, such that the tip end portion 31 and the tapered portion 33 of the insertion optical fiber 30 are located away from the connection end surface 20a on an outside of the ferrule 20.

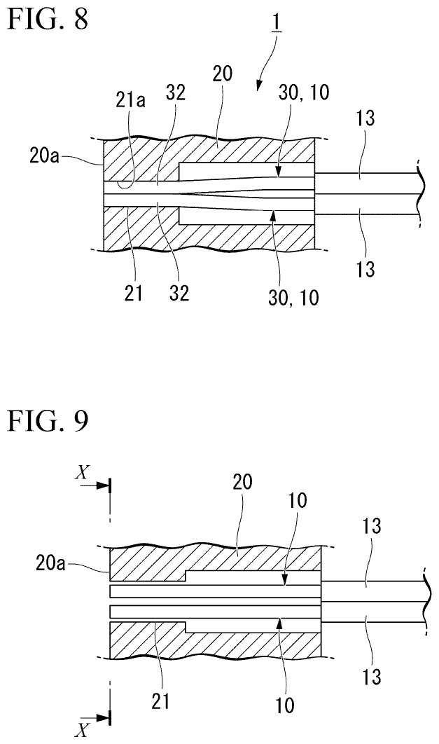

After the above-described fiber insertion step, a cutting step of cutting the insertion optical fiber 30 in the connection end surface 20a of the ferrule 20 is performed. As a result, as shown in FIG. 8, the tip end portion 31 of the insertion optical fiber 30 pulled out from the connection end surface 20a is removed. In addition, the tapered portion 33 pulled out from the connection end surface 20a is also removed. A part of the base end portion 32 pulled out from the connection end surface 20a may be removed. That is, the plurality of optical fibers 10 in the fiber bundle connector 1 after the manufacturing each has a cut portion (cut surface) where the insertion optical fiber 30 is cut on the connection end surface 20a of the ferrule 20. The cut portion is exposed on the connection end surface 20a. By performing this cutting step, the fiber bundle connector 1 is manufactured. In the cutting step, the tip end portion 31 and the tapered portion 33 of the insertion optical fiber 30 are removed such that the base end portion 32 of the insertion optical fiber 30 is located to correspond to the connection end surface 20a.

As shown in FIG. 8, in a state after the cutting step, the base end portion 32 of the insertion optical fiber 30 is configured as the optical fiber 10 (glass body) of the fiber bundle connector 1. That is, the base end portions 32 of the four insertion optical fibers 30 are most densely disposed as the four optical fibers 10 of the fiber bundle connector 1. In addition, the base end portions 32 of all the insertion optical fibers 30 located at the outermost periphery among the plurality of the insertion optical fibers 30 disposed most densely are pressed on the inner wall 22 of the fiber hole 21. In the present embodiment, the number of the insertion optical fibers 30 is four, and the four insertion optical fibers 30 are all located at the outermost periphery. Therefore, the base end portions 32 of all the insertion optical fibers 30 are pressed on the inner wall 22 of the fiber hole 21.

After the above-described cutting step, the connection end surface 20a of the ferrule 20 and the end surface of the base end portion 32 of the insertion optical fiber 30 exposed on the connection end surface 20a (the end surface of the optical fiber 10) may be polished.

In the fiber bundle connector 1 manufactured by the first manufacturing method described above, each of the plurality of optical fibers 10 is configured by continuously arranging the tip end portion 31 and the base end portion 32 having a diameter larger than that of the tip end portion 31, and consists of the insertion optical fiber 30 inserted into the fiber hole 21 of the ferrule 20. The plurality of optical fibers 10 in the fiber bundle connector 1 have the cut portion (cut surface) exposed on the connection end surface 20a by cutting the insertion optical fiber 30 in a state in which the base end portion 32 of the insertion optical fiber 30 is positioned on the connection end surface 20a of the ferrule 20 and removing the tip end portion 31 of the insertion optical fiber 30.

In the above-described first manufacturing method of the fiber bundle connector 1, a plurality of insertion optical fibers 30 are prepared such that the tip end portion 31 and the base end portion 32 having a diameter larger than the tip end portion 31 are continuously arranged. In addition, the tip end portions 31 of the plurality of insertion optical fibers 30 are inserted into the fiber hole 21 of the ferrule 20 and pulled out from the connection end surface 20a, whereby the base end portions 32 of the plurality of insertion optical fibers 30 are inserted into the fiber hole 21. In this state, the base end portions 32 of the plurality of insertion optical fibers 30 are most densely disposed in the fiber hole 21, and all the base end portions 32 located at the outermost periphery among these base end portions 32 are pressed on the inner wall 22 of the fiber hole 21. With this, the inner wall 22 of the fiber hole 21 elastically and plastically deforms. Further, after the base end portions 32 of the plurality of insertion optical fibers 30 are inserted into the fiber hole 21, the plurality of insertion optical fibers 30 are cut on the connection end surface 20a to remove the tip end portions 31 of the plurality of insertion optical fibers 30 pulled out from the connection end surface 20a to the outside of the ferrule 20. The base end portions 32 of the plurality of insertion optical fibers 30 inserted into the fiber hole 21 become the plurality of optical fibers 10 in the fiber bundle connector 1. The fiber bundle connector 1 may be manufactured by the first manufacturing method of the fiber bundle connector 1 described above.

As a result, it is possible to easily manufacture the fiber bundle connector 1 in which a plurality of optical fibers 10 are positioned in the fiber hole 21 with high accuracy.

### <Second Manufacturing Method>

Next, a second manufacturing method of the fiber bundle connector 1 will be described with reference to FIGS. 9 to 11.

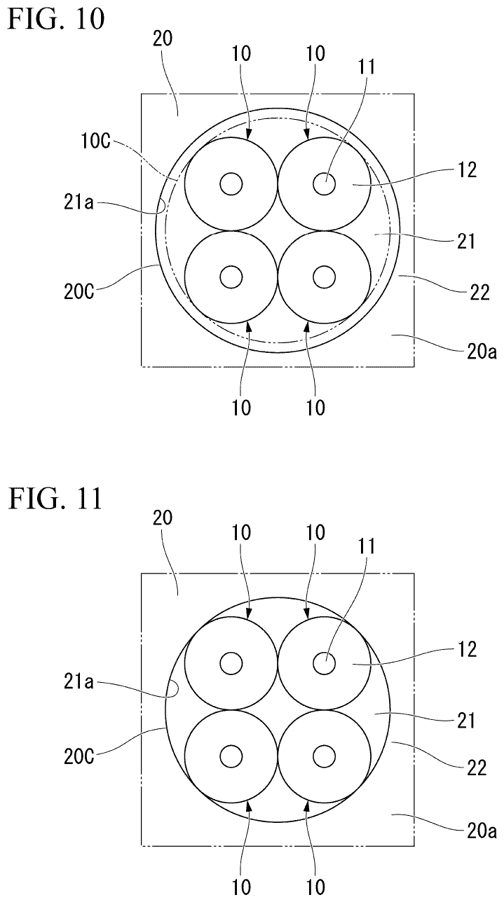

In the second manufacturing method, first, a ferrule preparation step of preparing the ferrule 20 shown in FIGS. 9 and 10 is performed. The ferrule 20 includes the fiber hole 21 that extends to the connection end surface 20a thereof and into which four optical fibers 10 (glass bodies) are inserted. The ferrule 20 is molded of resin. In the molded ferrule 20, in a cross section perpendicular to the longitudinal direction of the fiber hole 21, the inscribed circle 20C of the fiber hole 21 is larger than a circumscribed circle 10C when the four optical fibers 10 are most densely disposed.

After the ferrule preparation step described above, a fiber insertion step of inserting the four optical fibers 10 into the fiber hole 21 is performed. Here, as described above, the inscribed circle 20C of the fiber hole 21 is larger than the circumscribed circle 10C when the four optical fibers 10 are most densely disposed. Therefore, it is possible to easily insert the four optical fibers 10 into the fiber hole 21. In FIG. 9, the end surface of the optical fiber 10 is located to correspond to the connection end surface 20a of the ferrule 20, but the present invention is not limited to this.

After the above-described fiber insertion step, an annealing step of annealing the ferrule 20 is performed. In the annealing step, by annealing the ferrule 20, the inscribed circle 20C (see FIG. 11) of the fiber hole 21 is made to be smaller than the circumscribed circle 10C (see FIG. 10) when the four optical fibers 10 are most densely disposed. As a result, in a state after the annealing step, all the optical fibers 10 (that is, the four optical fibers 10) located at the outermost periphery of the four optical fibers 10 inserted into the fiber hole 21 are pressed on the inner wall 22 of the fiber hole 21, and the inner wall 22 elastically and plastically deforms. In the example shown in FIG. 11, the inscribed circle 20C of the fiber hole 21 is the same as the contour of the fiber hole 21 which is circular.

By performing the above-described annealing step, the fiber bundle connector 1 is manufactured. After the annealing step, for example, the connection end surface 20a of the ferrule 20 and the end surface of the optical fiber 10 exposed on the connection end surface 20a may be polished.

In the above-described second manufacturing method of the fiber bundle connector 1, the ferrule 20 is prepared by molding resin and includes the fiber hole 21 into which a plurality of optical fibers 10 are inserted. The inscribed circle 20C of the fiber hole 21 in the prepared ferrule 20 is larger than the circumscribed circle 10C when the plurality of optical fibers 10 are most densely disposed. After the plurality of optical fibers 10 are inserted into the fiber hole 21, the ferrule 20 is annealed to make the inscribed circle 20C of the fiber hole 21 smaller than the circumscribed circle 10C when the plurality of optical fibers 10 are most densely disposed. As a result, all the optical fibers 10 located at the outermost periphery among the plurality of optical fibers 10 disposed most densely in the fiber hole 21 are pressed on the inner wall 22 of the fiber hole 21. With this, the inner wall 22 of the fiber hole 21 elastically and plastically deforms. The fiber bundle connector 1 may be manufactured by the second manufacturing method of the fiber bundle connector 1 described above.

Thus, it is possible to easily manufacture the fiber bundle connector 1 in which a plurality of optical fibers 10 are positioned in the fiber hole 21 with high accuracy.

In addition, in the second manufacturing method, only the annealing is performed in a state in which the ferrule 20 is accommodated in a heating chamber after the optical fiber 10 is inserted into the fiber hole 21 of the ferrule 20, so that the inscribed circle 20C of the fiber hole 21 can be made smaller and the optical fiber 10 can be fitted into the fiber hole 21. As a result, the optical fiber 10 can be easily fitted into the fiber hole 21 as compared with a case where the optical fiber 10 is inserted into the fiber hole 21 in a chamber in a state in which the ferrule 20 accommodated in the chamber is heated to enlarge the inscribed circle 20C of the fiber hole 21.

For example, the first manufacturing method and the second manufacturing method described above may be appropriately combined. For example, the annealing step of annealing the ferrule 20 in the second manufacturing method may be performed after the fiber insertion step of inserting the base end portion 32 of the insertion optical fiber 30 into the fiber hole 21 in the first manufacturing method.

As described above, in the fiber bundle connector 1 and the manufacturing method thereof in the present embodiment, the plurality of optical fibers 10 inserted into the fiber hole 21 are most densely disposed such that the adjacent optical fibers 10 are in contact with each other in a cross section perpendicular to the longitudinal direction of the fiber hole 21. In addition, all the optical fibers 10 located at the outermost periphery among the plurality of optical fibers 10 disposed most densely are pressed on the inner wall 22 of the fiber hole 21. In addition, the inner wall 22 of the fiber hole 21 on which the optical fibers 10 are pressed elastically and plastically deforms. Since the adjacent optical fibers 10 are pressed by an elastic force of the inner wall 22 that has elastically and plastically deformed, it is possible to hold the plurality of optical fibers 10 inserted into the fiber hole 21 in a state in which the plurality of optical fibers 10 are most densely disposed. As a result, it is possible to position the plurality of optical fibers 10 in the fiber hole 21 with high accuracy. Thus, when the connection end surface 20a of the fiber bundle connector 1 is butted against the connection end surface of another optical fiber connector, it is possible to suppress the connection loss between the optical fibers of these connectors.

The “other optical fiber connector” described above may be the fiber bundle connector 1 in the present embodiment, or may be, for example, a multi-fiber connector in which a multi-core fiber is held by a ferrule.

In addition, in the present embodiment, the elastic modulus of the inner wall 22 of the fiber hole 21 is lower than the elastic modulus of the optical fiber 10 (glass body). As a result, it is possible to prevent deformation of the optical fiber 10 even though the optical fiber 10 inserted into the fiber hole 21 is pressed on the inner wall 22 of the fiber hole 21. That is, it is possible to protect the optical fiber 10.

Although the details of the present invention have been described above, the present invention is not limited to the above-described embodiment, and various modifications can be made without departing from the gist of the present invention.

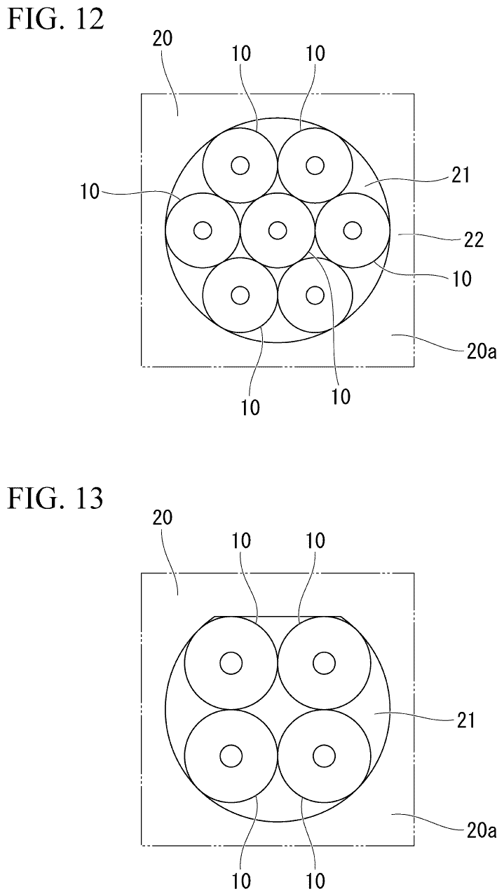

In the above-described embodiment, the number of the optical fibers 10 inserted into the fiber hole 21 is not limited to four. In addition, it is not necessary that all the plurality of optical fibers 10 inserted into the fiber hole 21 be pressed on the inner wall 22 of the fiber hole 21. For example, as shown in FIG. 12, with respect to the fiber hole 21 having a circular cross section that is perpendicular to the longitudinal direction of the optical fiber 10 and the fiber hole 21, six optical fibers 10 may be arranged in the circumferential direction of the fiber hole 21, and another one optical fiber 10 may be disposed inside these six optical fibers 10. In the structure shown in FIG. 12, the seven optical fibers 10 inserted into the fiber hole 21 are most densely disposed such that the adjacent optical fibers 10 are in contact with each other. In addition, the six optical fibers 10 located at the outermost periphery among the seven optical fibers 10 are pressed on the inner wall 22 of the fiber hole 21.

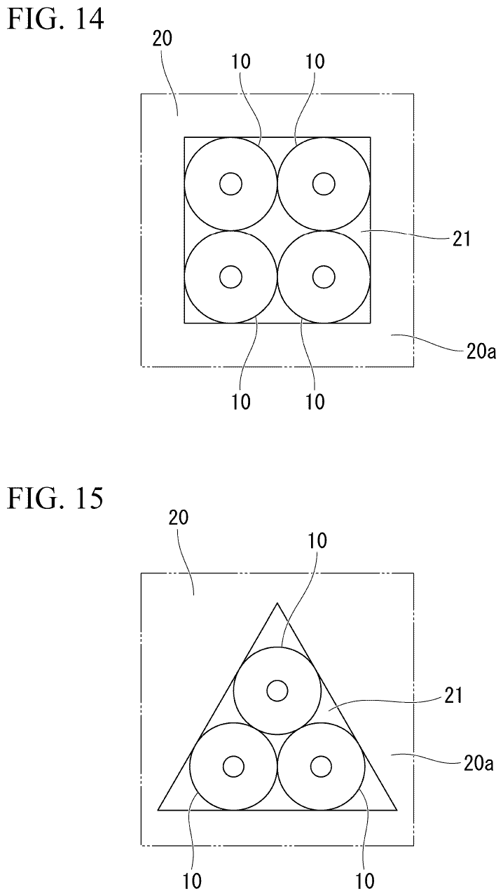

In the above-described embodiment, the cross-sectional shape of the fiber hole 21 perpendicular to the longitudinal direction of the fiber hole 21 is not limited to a circular shape, and may be various shapes as shown in FIGS. 13 to 15. A cross-sectional shape of the fiber hole 21 shown in FIG. 13 is a shape in which a part of a circular shape in the circumferential direction is replaced with a straight line. A cross-sectional shape of the fiber hole 21 shown in FIG. 14 is a rectangular shape. In FIGS. 13 and 14, the number of the optical fibers 10 inserted into the fiber hole 21 is four, but the present invention is not limited to this. A cross-sectional shape of the fiber hole 21 shown in FIG. 15 is a triangular shape. In FIG. 15, the number of the optical fibers 10 inserted into the fiber hole 21 is three, but the present invention is not limited to this.

In the above-described embodiment, the inner wall 22 elastically and plastically deforms on at least the connection end surface 20a of the ferrule 20 in the fiber hole 21, when the optical fibers 10 are most densely disposed such that the adjacent optical fibers 10 are in contact with each other, and all the optical fibers 10 located at the outermost periphery among the plurality of optical fibers 10 disposed most densely are pressed on the inner wall 22 of the fiber hole 21. Therefore, the fiber hole 21 is not limited to being formed to have the same size over the longitudinal direction thereof, and may be formed to be larger as it becomes farther from the connection end surface 20a in the longitudinal direction of the fiber hole 21.

In the above-described embodiment, the number of the optical fibers 10 (or the insertion optical fibers 30) inserted into the fiber hole 21 of the ferrule 20 may be, for example, one. That is, the above-described embodiment is not limited to the fiber bundle connector 1 in which a plurality of optical fibers 10 are bundled and held by the ferrule 20, and may be applied to a fiber connector in which one optical fiber 10 is held by the ferrule 20. In a case where the fiber connector is manufactured by the first manufacturing method, a circumscribed circle when the tip end portion 31 and the base end portion 32 of the insertion optical fiber 30 are most densely disposed may be a circumscribed circle of the tip end portion 31 and the base end portion 32 of one insertion optical fiber 30, respectively. In addition, in a case where the fiber connector is manufactured by the second manufacturing method, the circumscribed circle when the optical fibers 10 are most densely disposed may be a circumscribed circle of one optical fiber 10.

In the above-described embodiment, the inner wall 22 of the fiber hole 21 is not limited to being configured to elastically and plastically deform, and may be configured to elastically deform, for example.

### REFERENCE SIGNS LIST

1: Fiber bundle connector
10: Optical fiber
10C: Circumscribed circle
20: Ferrule
20a: Connection end surface
21: Fiber hole
22: Inner wall
20C: Inscribed circle
30: Insertion optical fiber
31: Tip end portion
31C: Circumscribed circle
32: Base end portion

1. A fiber bundle connector, comprising:
a plurality of optical fibers; and
a ferrule that has a connection end surface and a fiber hole that extends to the connection end surface and into which the plurality of optical fibers are inserted,
wherein the plurality of optical fibers inserted into the fiber hole are most densely disposed on at least the connection end surface such that adjacent optical fibers are in contact with each other, and
all the optical fibers located at an outermost periphery among the plurality of optical fibers disposed most densely are pressed on an inner wall of the fiber hole to cause the inner wall to elastically and plastically deform.

2. The fiber bundle connector according to claim 1, wherein each of the plurality of optical fibers includes cut portion by removing a tip end portion of the optical fibers at the connection end surface when a base end portion of the optical fibers is positioned on the connection end surface, wherein each of the plurality of optical fibers had been configured by continuously arranging the tip end portion and the base end portion having a diameter larger than a diameter of the tip end portion.

3. The fiber bundle connector according to claim 1, wherein
base end portions of a plurality of insertion optical fibers which are the plurality of optical fibers inserted into the fiber hole are most densely disposed on at least the connection end surface, and all the optical fibers located at an outermost periphery among the plurality of optical fibers disposed most densely are pressed on the inner wall of the fiber hole, by
preparing the plurality of insertion optical fibers in which tip end portions and the base end portions that each has a diameter larger than a diameter of each of the tip end portions are arranged continuously,
wherein, in a cross section perpendicular to a longitudinal direction of the insertion optical fiber,
a circumscribed circle when the plurality of tip end portions are most densely disposed is smaller than an inscribed circle of the fiber hole in at least the connection end surface, and
a circumscribed circle when the plurality of base end portions are most densely disposed is larger than at the inscribed circle of the fiber hole in at least the connection end surface, and
inserting the tip end portions of the plurality of insertion optical fibers into the fiber hole and pulling out from the connection end surface, so as to have the base end portions of the plurality of insertion optical fibers inserted into the fiber hole, and then cutting the insertion optical fibers on the connection end surface, and removing the tip end portions of the insertion optical fibers pulled out from the connection end surface.

4. The fiber bundle connector according to claim 1, wherein
the plurality of the optical fibers are most densely disposed in at least the connection end surface, and all the optical fibers located at an outermost periphery among the plurality of the optical fibers disposed most densely are pressed on the inner wall of the fiber hole by
preparing a ferrule in which, in a cross section perpendicular to a longitudinal direction of the fiber hole, an inscribed circle of the fiber hole in at least the connection end surface is larger than a circumscribed circle when a plurality of the optical fibers are most densely disposed, wherein the ferrule being molded of resin, and
annealing the ferrule after the optical fibers are inserted into the fiber hole, such that the inscribed circle of the fiber hole in at least the connection end surface is made to be smaller than the circumscribed circle when the plurality of the optical fibers are most densely disposed.

5. The fiber bundle connector according claim 1, wherein an elastic modulus of the inner wall of the fiber hole is lower than an elastic modulus of the optical fibers.

6. A fiber connector manufacturing method for manufacturing a fiber connector including an optical fiber, and a ferrule having a connection end surface and a fiber hole that extends to the connection end surface and into which the optical fiber is inserted, the method comprising:
a fiber preparation step of preparing an insertion optical fiber in which a tip end portion and a base end portion that has a diameter larger than a diameter of the tip end portion are arranged continuously,
wherein in a cross section perpendicular to a longitudinal direction of the insertion optical fiber,
a circumscribed circle when the tip end portion is most densely disposed is smaller than an inscribed circle of the fiber hole in at least the connection end surface, and
a circumscribed circle when the base end portion is most densely disposed is larger than at the inscribed circle of the fiber hole in at least the connection end surface;
a fiber insertion step of inserting the base end portion of the insertion optical fiber into the fiber hole by inserting the tip end portion of the insertion optical fiber into the fiber hole and pulling the tip end portion of the insertion optical fiber out from the connection end surface after the fiber preparation step; and
a cutting step of removing the tip end portion of the insertion optical fiber pulled out from the connection end surface by cutting the insertion optical fiber in the connection end surface after the fiber insertion step,
wherein, in a state after the fiber insertion step, the base end portion of every insertion optical fiber located at an outermost periphery among the base end portion of the insertion optical fiber inserted into the fiber hole is pressed on an inner wall of the fiber hole to cause the inner wall to elastically and plastically deform, and
in a state after the cutting step, the base end portion of the insertion optical fiber functions as the optical fiber in the fiber connector.

7. A fiber connector manufacturing method for manufacturing a fiber connector including an optical fiber, and a ferrule having a connection end surface and a fiber hole that extends to the connection end surface and into which the optical fiber is inserted, the method comprising:
a ferrule preparation step of preparing a ferrule in which, in a cross section perpendicular to a longitudinal direction of the fiber hole, an inscribed circle of the fiber hole in at least the connection end surface is larger than a circumscribed circle when the optical fiber is most densely disposed, wherein the ferrule being molded of resin;
a fiber insertion step of inserting the optical fiber into the fiber hole after the ferrule preparation step; and
an annealing step of annealing the ferrule after the fiber insertion step, so that the inscribed circle of the fiber hole in at least the connection end surface is made to be smaller than the circumscribed circle when the optical fiber is most densely disposed,
wherein, in a state after the annealing step, the optical fiber located at an outermost periphery among the optical fiber inserted into the fiber hole is pressed on an inner wall of the fiber hole to cause the inner wall to elastically and plastically deform.
